(19) United States
(12) Patent Application Publication
(10) Pub. No.: US 2013/0314547 A1
(43) Pub. Date: Nov. 28, 2013

(54) CONTROLLING APPARATUS FOR AUTOMATIC TRACKING CAMERA, AND AUTOMATIC TRACKING CAMERA HAVING THE SAME

(71) Applicant: CANON KABUSHIKI KAISHA, Tokyo (JP)

(72) Inventor: Harukazu Watanabe, Utsunomiya-shi (JP)

(73) Assignee: CANON KABUSHIKI KAISHA, Tokyo (JP)

(21) Appl. No.: 13/901,114

(22) Filed: May 23, 2013

(30) Foreign Application Priority Data
May 25, 2012 (JP) 2012-119815

(51) Int. Cl. H04N 5/232

(52) U.S. Cl. CPC H04N 5/232
USPC 348/169

(57) ABSTRACT

A controller for a tracking camera for automatically tracking an object by controlling panning/tilting and zooming of an image pickup apparatus mounted on a camera platform includes an object recognition unit that recognizes an object in picked-up image, a setting unit that sets a tracking condition, a memory that stores at least one tracking condition, a readout unit that reads out the tracking condition, and a controller that controls panning/tilting of the platform and zooming of the image pickup apparatus to track the object under the condition, wherein the condition includes an output position in the picked-up image, and a display size of the object in the picked-up image, the setting unit includes an output position setting unit, and a display size setting unit, the memory stores the output position and/or the display size, and the readout unit reads out the output position and/or the display size.

### BACKGROUND OF THE INVENTION

1. Field of the Invention

The present invention relates to a controlling apparatus for an automatic tracking camera for tracking a tracking object, and an automatic tracking camera having the controlling apparatus and, more particularly, to an operating apparatus for the automatic tracking camera and an automatic tracking controlling method.

2. Description of the Related Art

An electrical platform camera in which an electrical camera platform capable of panning and tilting operations is attached to a camera is connected to an operating apparatus via a cable or wirelessly to enable camera platform control and camera control from a remote site. While observing an image displayed on the monitor display, the operator operates the operating apparatus to control the camera and electrical camera platform.

This camera platform system has a preset function of registering in advance in the shot button of the operating apparatus, desired image pickup positions of the camera and electrical camera platform such as zoom, pan, and tilt positions, and pressing again the shot button to change the current image pickup positions to the registered ones.

Recently, there is proposed an automatic tracking camera system which applies an image recognition technique to a platform camera and automatically tracks an object.

Japanese Patent Application Laid-Open No. H06-086136 discloses a preset function of changing the composition to a registered desired image pickup position by pressing a shot button.

Japanese Patent Application Laid-Open No. H05-021941 discloses a means for setting a composition in an angle-of-field setting unit by using, as initial data, central position data of the face image of a person on an initial display, and distance data of the face image in the lateral and longitudinal directions, and when tracking starts, automatically tracking an object to locate it at an initial setting position.

When automatically tracking a reporter or newscaster in a TV station or the like, the operator sometimes wants to change the output position and size of a current object on the display, that is, the composition of the object during tracking. For example, when an object holds a flip board or commodity, the operator may want to locate the flip board or commodity at the center of the display and locate the object at the right or left end of the display.

The preset function described in Japanese Patent Application Laid-Open No. H06-086136 stores the image pickup positions (e.g., pan, tilt, and zoom positions) of the camera and electrical camera platform, but does not store the output position and size (angle of field) of an object on the display. When automatically tracking a moving object, even if the operator presses the shot button, a desired tracking object does not always exist on the display, and the operator cannot change the composition and angle of field containing the object. That is, the conventional preset function cannot be used during automatic tracking.

In Japanese Patent Application Laid-Open No. H05-021941, when the operator wants to change the composition and angle of field during tracking, he needs to change initial data, complicating the operation. Further, Japanese Patent Application Laid-Open No. H05-021941 does not disclose a method of changing initial data.

### SUMMARY OF THE INVENTION

The present invention has been made to solve the above problems, and provides a controlling apparatus for an automatic tracking camera that can easily set in advance a composition and angle of field containing a desired tracking object, and instantaneously change the composition and angle of field containing the object during tracking.

According to one aspect of the present invention, there is provided a controlling apparatus for an automatic tracking camera for automatically tracking an object by controlling pan/tilt driving and zoom driving of an image pickup apparatus mounted on a camera platform apparatus, including an object recognition unit that recognizes an object by image recognition in a picked-up image, a setting unit that sets a tracking condition of a tracking object, a memory that stores at least one tracking condition set by the setting unit, a readout unit that reads out the at least one tracking condition stored in the memory, and a controlling unit that controls pan/tilt driving of the camera platform apparatus and zoom driving of the image pickup apparatus to track the tracking object under the tracking condition read out from the memory by the readout unit, wherein the tracking condition includes an output position serving as a position to which the tracking object is output in the picked-up image, and a display size serving as a size of the tracking object to be displayed in the picked-up image, the setting unit includes an output position setting unit that sets the output position, and a display size setting unit that sets the display size, the memory stores at least one of the output position set by the output position setting unit, and the display size set by the display size setting unit, and the readout unit reads out at least one of the output position and the display size that is stored in the memory.

According to an automatic tracking camera controlling apparatus, automatic tracking camera system, and automatic tracking camera controlling method, the operator can set, in advance by a simple operation, a composition and angle of field containing a desired tracking object, and can instantaneously change the object to a desired composition and angle of field during tracking.

Further features of the present invention will become apparent from the following description of exemplary embodiments with reference to the attached drawings.

### BRIEF DESCRIPTION OF THE DRAWINGS

FIG. 1 is a view showing an arrangement according to the first embodiment;

FIG. 2 is a view showing a monitor display which displays a tracking object frame;

FIG. 3 is a flowchart before the start of tracking according to the first embodiment, and also shows a monitor display;

FIG. 4 is a flowchart after the start of tracking according to the first embodiment;

FIG. 5 is a flowchart before the start of tracking according to the second embodiment, and also shows a monitor display;

FIG. 6 is a flowchart after the start of tracking according to the second embodiment;

FIG. 7 is a flowchart before the start of tracking according to the third embodiment; and

FIG. 8 is a flowchart after the start of tracking according to the third embodiment.

### DESCRIPTION OF THE EMBODIMENTS

Preferred embodiments of the present invention will now be described in detail in accordance with the accompanying drawings.

### First Embodiment

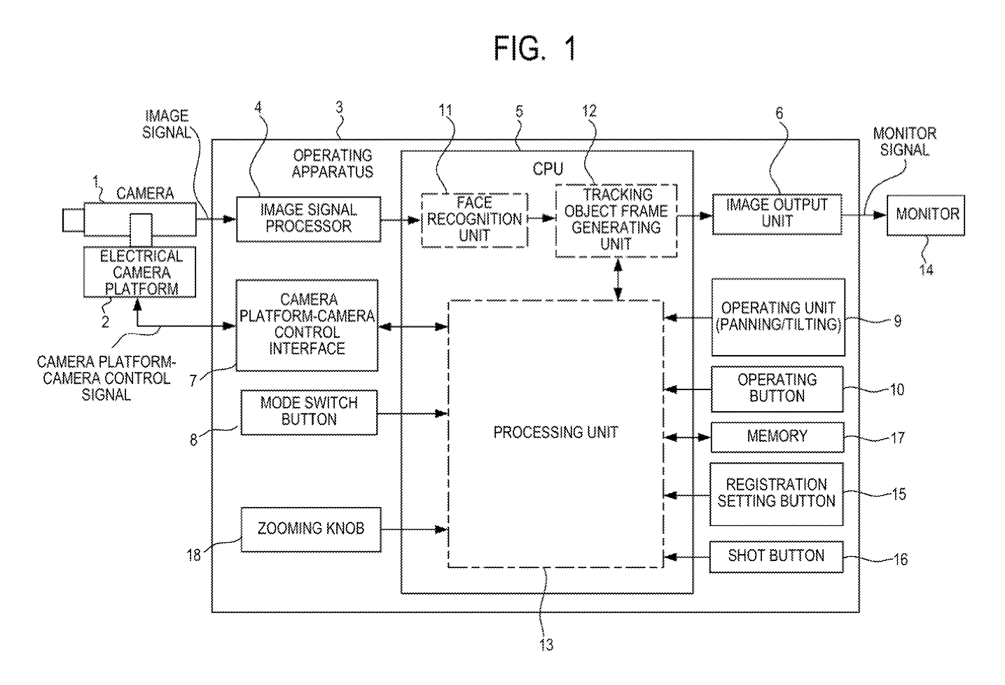

FIG. 1 is a view showing the arrangement of a controlling apparatus for an automatic tracking camera which automatically tracks an object by controlling pan/tilt driving and zoom driving of an image pickup apparatus mounted on a camera platform apparatus according to the first embodiment.

In FIG. 1, a camera 1 equipped with a lens having zooming and focusing functions and the like is attached to an electrical camera platform 2 capable of a panning operation to drive the camera 1 in the pan direction and a tilting operation to drive it in the tilt direction. The camera 1 and electrical camera platform 2 undergo camera control such as zooming and gain adjustment, and camera platform control such as panning and tilting operations (to be referred to as a panning/tilting operation hereinafter) by an operating apparatus 3 installed at a remote site.

An image signal output from the CCD of the camera 1 is input to an image signal processor 4 of the operating apparatus 3 that controls the camera 1 and the electrical camera platform 2 supporting the camera 1 based on an operation by the operator. In addition to the image signal processor 4, the operating apparatus 3 incorporates a CPU 5, an image output unit 6, a platform-camera control interface 7, a mode switch button 8, an operating unit 9, an operating button 10, a registration setting button 15, a plurality of shot buttons 16, a memory 17, and a zooming knob 18. The CPU 5 incorporates a face recognition unit 11, tracking object frame generating unit 12, and processing unit 13.

An output from the image signal processor 4 is input to the processing unit 13 via the face recognition unit 11 and tracking object frame generating unit 12. An output from the tracking object frame generating unit 12 is input to a monitor 14 outside the operating apparatus 3 via the image output unit 6. Although the operating apparatus 3 is connected to the external monitor in the embodiment, it may incorporate an internal monitor such as a liquid crystal monitor. The processing unit 13 is connected to the electrical camera platform 2 via the platform-camera control interface 7. Further, the mode switch button 8, operating unit 9, registration setting button 15, shot buttons 16, memory 17, and zooming knob 18 are connected to the processing unit 13.

When an input image signal is an analog signal, the image signal processor 4 converts it into a digital signal, and adjusts the contrast, hue, saturation, and the like of the image. An output image signal from the image signal processor 4 is input to the face recognition unit 11 inside the CPU 5.

When a picked-up image output from the image signal processor 4 contains a person, the face recognition unit 11 serving as an object recognition unit performs face recognition according to a face recognition technique based on image recognition such as template matching. Although a person's face is recognized in the embodiment, an object other than a person may be recognized using the template of a vehicle, airplane, or the like.

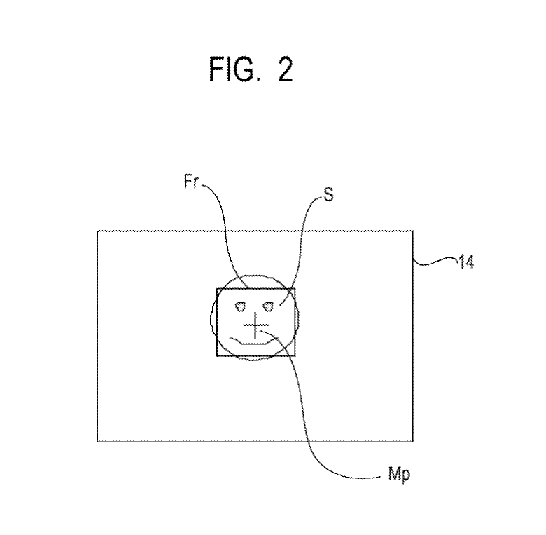

The position coordinates of a recognized face on the display are input to the tracking object frame generating unit 12. A tracking object frame Fr serving as a tracking object mark is generated on an object S based on the position coordinates of the recognized face, as shown in FIG. 2.

A signal obtained by compositing the tracking object frame Fr on the input image by the tracking object frame generating unit 12 is input to the image output unit 6. The image output unit 6 outputs a monitor signal obtained by conversion into an image signal of a format such as SDI, DVI, VGA, or NTSC corresponding to the image input format of the monitor 14 serving as a display unit.

The operating unit 9 allows the operator to perform a manual operation of panning/tilting the electrical camera platform 2. The operating unit 9 includes a joystick, up, down, left, and right arrow key buttons, a pointing device such as a mouse, and a touch panel.

The operating button 10 is a button for starting tracking in the embodiment. However, by applying an existing button, the CPU 5 may set the operating button 10 as a tracking start button in the tracking mode, and a button for performing another function in the normal mode.

The operating apparatus 3, camera 1, and electrical camera platform 2 use the platform-camera control interface 7 to communicate each other in a predetermined communication format.

The mode switch button 8 is a button serving as a switch unit which allows the operator to select the normal mode in which the operating apparatus 3 is used as a normal operating apparatus or the tracking mode in which it is used as a tracking operating apparatus. Although the mode switch button 8 is provided as shown in FIG. 1 in the embodiment, an existing button may be applied and pressed and held to switch the mode.

When the mode switch button 8 is in the normal mode, the registration setting button 15 is used together with the shot button 16 in order to store the pan and tilt positions of the camera platform 2 and the zoom and focus positions of the camera 1. If the operator presses the registration setting button 15 and then presses one shot button 16 of a number to be registered, desired image pickup positions such as the pan and tilt positions of the camera platform 2 and the zoom and focus positions of the camera 1 at this time are stored in the built-in memory (not shown) of the camera platform 2. To read out the stored desired image pickup positions, the operator presses one of the shot buttons 16 to read out the desired image pickup positions from the built-in memory of the camera platform and control the camera platform 2 and camera 1 to the readout positions.

When the mode switch button 8 is in the tracking mode, the registration setting button 15 is used together with the shot button 16 to change to a function of storing, as tracking conditions, the output position of an object to be tracked on the display and its size on the display (display size in the picked-up image (on the display)). A method of setting the output position and size of a desired tracking object on the display will be described later. If the operator presses the registration setting button 15 and then presses one shot button 16 of a number to be registered, the memory 17 of the operating apparatus 3 stores a combination of central coordinates Mp of the tracking object frame Fr on the display and the size (longitudinal and lateral lengths) of the tracking object frame Fr, as shown in FIG. 2. This combination is a combination of the values (coordinate values) of the central coordinates (the coordinates of a predetermined position other than the center, for example, those of the end of the frame are also possible) of the tracking object frame, and the value of the size (longitudinal and lateral lengths because the object frame shape is generally a rectangle) of the tracking object frame. When the tracking object frame is a circle, an ellipse, or a polygon having five or more corners, other than a rectangle (square), the values of parameters (e.g., radius, major axis, and minor axis) which specify the tracking object frame indicate the size of the tracking object frame. When the operator presses the operating button 10 to start tracking, and then presses the shot button 16 of the registered number, the CPU 5 obtains the central coordinates and size of the tracking object frame of a current tracking object on the display (in the picked-up image). The CPU 5 compares the obtained central coordinates and size with the central coordinates and size of the tracking object frame that have been read out from the memory 17, and calculates differences. If each difference is equal to or larger than a predetermined value as a result of the calculation, the CPU 5 outputs driving signals as camera platform/camera control signals for controlling to drive the camera 1 and electrical camera platform 2 to cancel the difference. The driving signals are output on condition that the difference is equal to or larger than a predetermined value, in order to prevent a frequent motion of the display and resultant poor visibility when the electrical camera platform 2 is operated or zooming is changed for only a small difference.

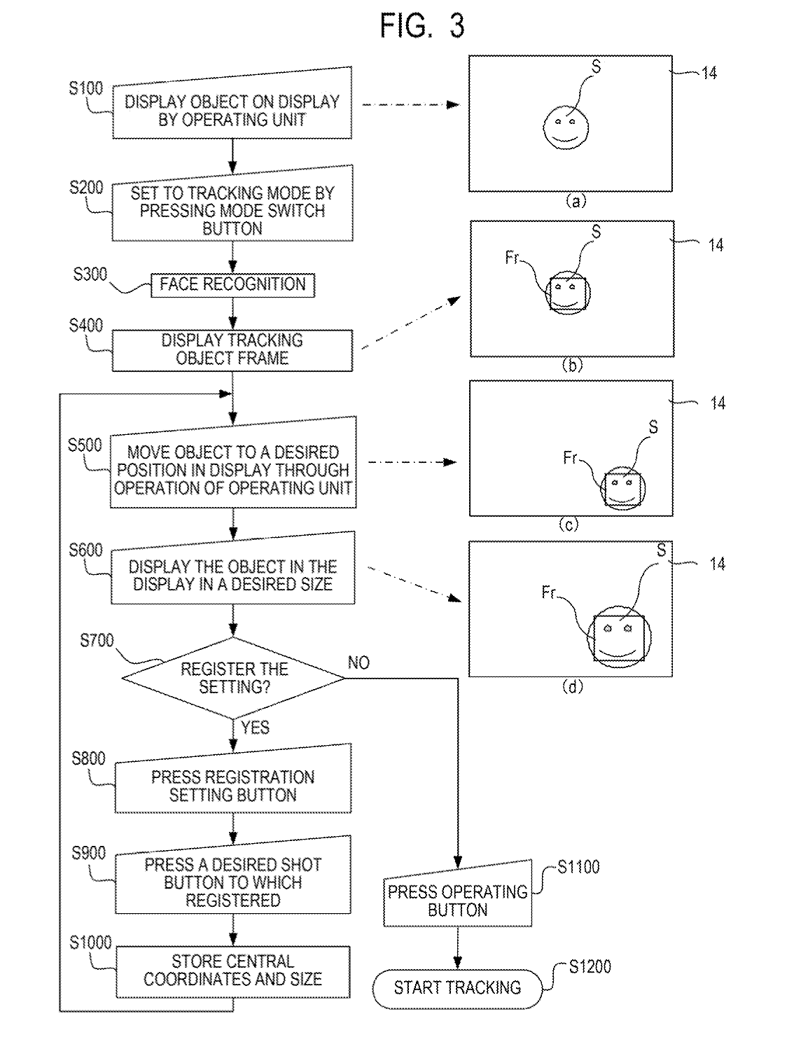

FIG. 3 is a flowchart showing a method of setting and registering in advance the composition and angle of field of a desired tracking object before the start of the tracking operation. FIG. 3 also shows a monitor display corresponding to each step. In FIG. 3, (a) to (d) are display examples on the monitor 14 in steps S100, S400, S500, and S600 in the processing flow of steps S100 to S1200.

When performing automatic tracking, the operator first pans and tilts the electrical camera platform 2 by using the operating unit 9, and moves it so that the tracking object S is displayed on the monitor 14, as represented in (a) (step S100). Then, the operator sets the tracking mode by pressing the mode switch button 8 in FIG. 1 (step S200). If the face recognition unit 11 recognizes a face (step S300), the tracking object frame Fr is displayed near the face, as represented in (b) (step S400). The operator moves the tracking object S to a desired output position on the display by operating again the operating unit 9, as represented in (c) (step S500). The operator displays the tracking object S in the picked-up image (on the display) in a desired size by operating the zooming knob 18 serving as a display size setting unit, as represented in (d) (step S600). If the operator wants to start tracking at the output position and size of the tracking object S on the display at this time, the process advances to step S1100; if he wants to register the setting, to step S800 (step S700). If the operator is to register the setting, he presses the registration setting button 15 (step S800), and presses one shot button 16 to which the setting is to be registered (step S900). Then, a combination of the central coordinates Mp and size Ft of the tracking object frame Fr is stored in the memory 17 (step S1000). If the operator wants to set a composition and angle of field subsequently, steps S500 to S1000 are repeated. If the operator wants to start tracking, he presses the operating button 10 (step S1100) and starts tracking (step S1200). The method of setting and registering the composition and angle of field of a desired tracking object before the start of tracking has been described.

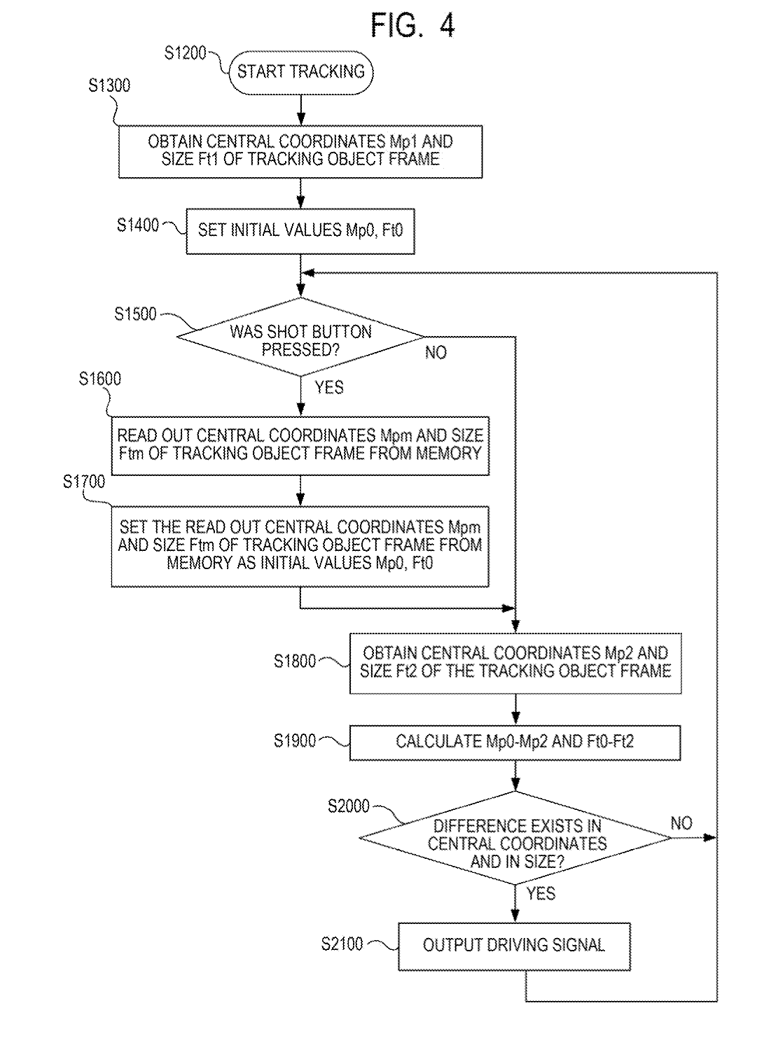

FIG. 4 is a flowchart showing a method of changing the composition and angle of field of a desired tracking object after the start of tracking.

After tracking starts (step S1200), a combination of central coordinates Mp1 and a size Ft1 of the tracking object frame of the tracking object S on the display immediately after the start of tracking is obtained (step S1300), and their values are set as initial values Mp0 and Ft0 (step S1400). Then, whether the shot button has been pressed is determined, and if the shot button has not been pressed, central coordinates Mp2 and a size Ft2 of the tracking object frame of a current tracking object on the display are obtained (step S1800). The processing unit 13 in the CPU 5 calculates the difference between the central coordinates Mp0 and Mp2 of the tracking object frame, and the difference between the sizes Ft0 and Ft2 of the tracking object frame (step S1900). It is determined whether a difference exists in central coordinates and size as a result of the calculation (step S2000). If a difference exists in step S1800, driving signals are output as camera platform/camera control signals for controlling to drive the camera 1 and electrical camera platform 2 to cancel the difference (step S2100). The tracking object S is moved by controlling at least one of zooming to change the focal length of the camera 1 and the panning/tilting operation of the electrical camera platform 2. Until the operator presses one shot button 16 in step S1500, steps S1800 to S2100 are repeated to perform automatic tracking.

If the operator presses one shot button 16 in step S1500, a combination of central coordinates Mpm and a size Ftm of the tracking object frame that have been registered is read out from the memory 17 into the CPU 5 (step S1600). These values are set as new initial values Mp0 and Ft0 (step S1700). At this time, a tracking object frame read out from the memory 17 may be displayed with a different color, line thickness, and the like on the display. After that, until the operator presses again one shot button 16 in step S1500, steps S1800 to S2100 are repeated. That is, driving signals are output as camera platform/camera control signals for controlling to drive the camera 1 and electrical camera platform 2 to set the tracking object to the position and size read out from the shot button 16. In this manner, by pressing one shot button 16 during the tracking operation, one position and size are read out from one or more stored combinations each of a position and size. The composition and angle of field of a desired tracking object can be changed during tracking.

### Second Embodiment

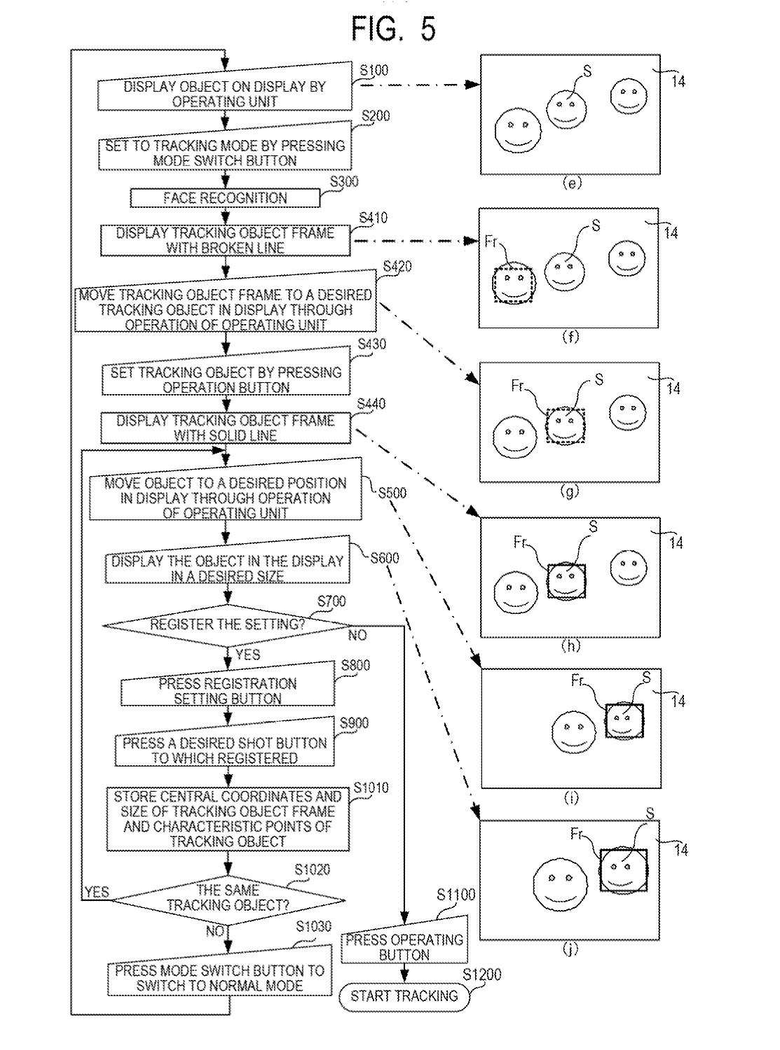

FIG. 5 is a flowchart before the start of tracking according to the second embodiment. FIG. 5 also shows a monitor display corresponding to each step. In FIG. 5, (e) to (j) are display examples on a monitor 14 in steps S100, S410, S500, and S600 in the processing flow of steps S100 to S1200. The second embodiment is different from the first embodiment in that it is added to select (designate) a desired tracking object S from a plurality of objects, and the characteristic points of the object are also stored in association with a shot button 16.

When performing tracking, the operator first pans and tilts an electrical camera platform 2 by using an operating unit 9, and moves it so that objects including the tracking object S are displayed on the monitor 14, as represented in (e) (step S100). Then, similar to the first embodiment, the operator sets the tracking mode by pressing a mode switch button 8 in FIG. 1 (step S200). If a plurality of objects exists on the display, a tracking object frame Fr is displayed with a broken line on an object having undergone face recognition first (S300), as represented in (f) (step S410). If the object displayed with the tracking object frame Fr is not the object S to be tracked, the operator moves the tracking object frame Fr to the object S to be tracked by operating the operating unit 9, as represented in (g) (step S420). If the object S displayed with the tracking object frame Fr is the target object to be tracked, the operator sets the object by pressing an operating button 10 (step S430). The tracking object frame Fr is displayed with a solid line, as represented in (h) (step S440). In the second embodiment, a function of setting a tracking object is assigned by a CPU 5 to the operating button 10 in step S430, and a tracking start button when starting tracking is assigned in step S1100. Steps up to step S440 are object selection steps of selecting a desired tracking object. In the second embodiment, the operating unit 9 is operated to move the tracking object frame Fr to a desired tracking object, and select the object. It is also possible to use a touch panel, and touch and select a desired tracking object.

Steps S500 to S900 are the same as steps S500 to S900 in the first embodiment shown in FIG. 3, and a detailed description thereof will not be repeated.

In the first embodiment, when one shot button 16 to which the setting is to be registered is pressed in step S900, only the central coordinates and size of the tracking object frame are stored. In the second embodiment, when one shot button 16 to which the setting is to be registered is pressed (step S900), a combination of the characteristic points of an object, including the ratio of the distance between both eyes, that between the eye and the nostril, and that between the eye and the mouth, which is object identifying information for identifying an object, is stored in addition to the central coordinates and size of the tracking object frame (step S1010). This enables individual registration (object registration). When the object is a person, the object identifying information can be the ratio of the distance between both eyes, that between the eye and the nostril, and that between the eye and the mouth, as described above. However, the present invention is not limited to this, and object identifying information can be obtained by a known image processing method using the profile of characteristic portions of a vehicle or airplane, its contour, or the like. If the operator wants to set a composition and angle of field for the same tracking object subsequently, he can register a combination of one or more tracking conditions by repeating steps S500 to S1020. If the operator wants to set a composition and angle of field for another object, he temporarily returns the tracking mode to the normal mode by pressing the mode switch button 8 (step S1030), and starts again the process from step S100.

If the operator wants to start tracking, he presses the operating button 10 in step S700 (step S1100) and starts the tracking operation (step S1200). The method of setting the composition and angle of field of a desired tracking object, and registering a specific object as a tracking condition before the start of tracking has been described.

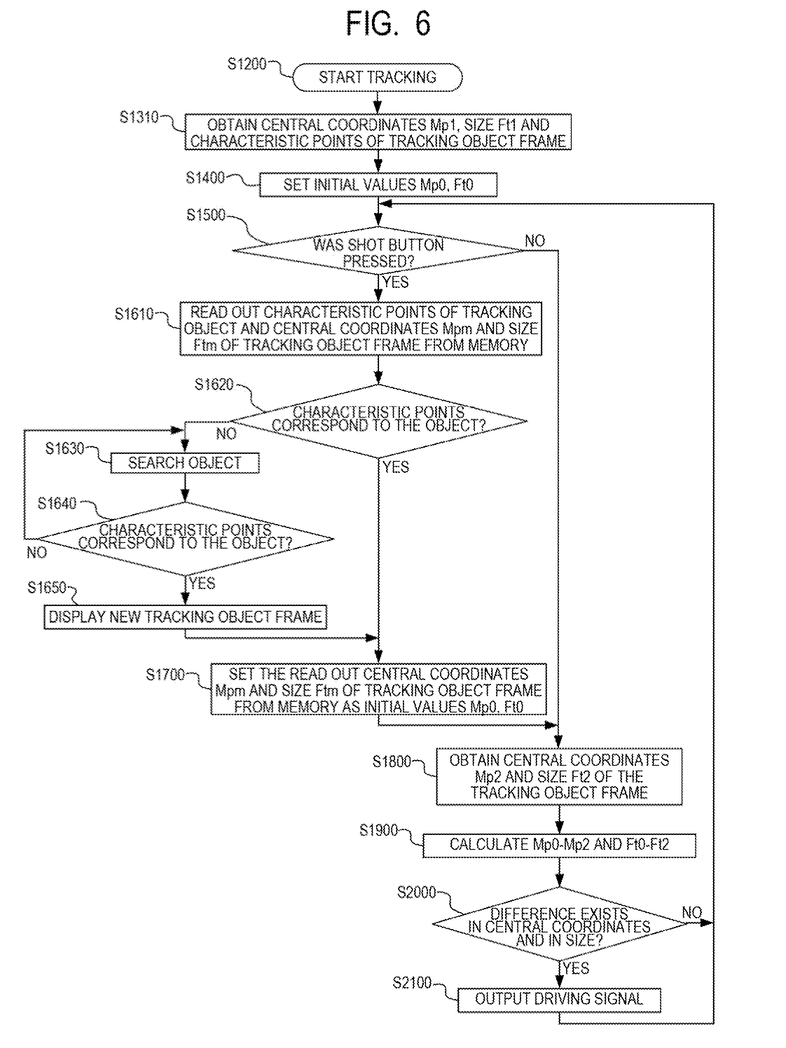

FIG. 6 is a flowchart showing a method of changing a desired tracking object, composition, and angle of field after the start of tracking.

After tracking starts (step S1200), central coordinates Mp1, a size Ft1, and characteristic points of the tracking object frame of a tracking object S on the display immediately after the start of tracking are obtained (step S1310). Similar to step S1400 in the first embodiment, the central coordinates Mp1 and size Ft1 of the tracking object frame are set as initial values Mp0 and Ft0 (step S1400). Steps S1500 to S2100 are the same as steps S1500 to S2100 in the first embodiment, and a detailed description thereof will not be repeated.

If the operator presses one shot button 16 in step S1500, the characteristic points of the object, central coordinates Mpm and a size Ftm (tracking conditions) of the tracking object frame that have been registered are read out from a memory 17 (step S1610). It is then determined whether the characteristic points of the object on which the tracking object frame is displayed, and the readout characteristic points coincide with each other (step S1620). If these characteristic points coincide with each other, the central coordinates Mpm and size Ftm of the tracking object frame that have been read out from the memory 17 are set as new initial values Mp0 and Ft0 (step S1700). Thereafter, until the operator presses again one shot button 16 in step S1500, steps S1800 to S2100 are repeated.

If the characteristic points (pieces of object identifying information) do not coincide with each other in step S1620, another object is searched for on the display until the characteristic points coincide with each other (step S1630). If the characteristic points coincide with each other (step S1640), the tracking object frame is newly displayed on the object corresponding to the characteristic points (step S1650). Then, the process advances to step S1700, and steps S1800 to S2100 are repeated until it is determined in step S1500 that one shot button 16 is pressed again.

In this way, by pressing one shot button 16 during the tracking operation, tracking conditions including a desired tracking object, composition, and angle of field can be changed during tracking.

### Third Embodiment

In the first embodiment, a combination of the central coordinates and size of the tracking object frame is stored in association with the shot button 16. In the second embodiment, the combination is stored together with the characteristic points of an object. In the third embodiment, a registration setting button 15 has a function of switching the registration mode between an object registration mode and a composition/angle of field registration mode. In the object registration mode, only the characteristic points of an object are stored in association with a shot button 16. In the composition/angle of field registration mode, only the composition and angle of field are registered. The third embodiment is different from the first and second embodiments in that a desired tracking object, and a desired output position and size on the display can be freely combined.

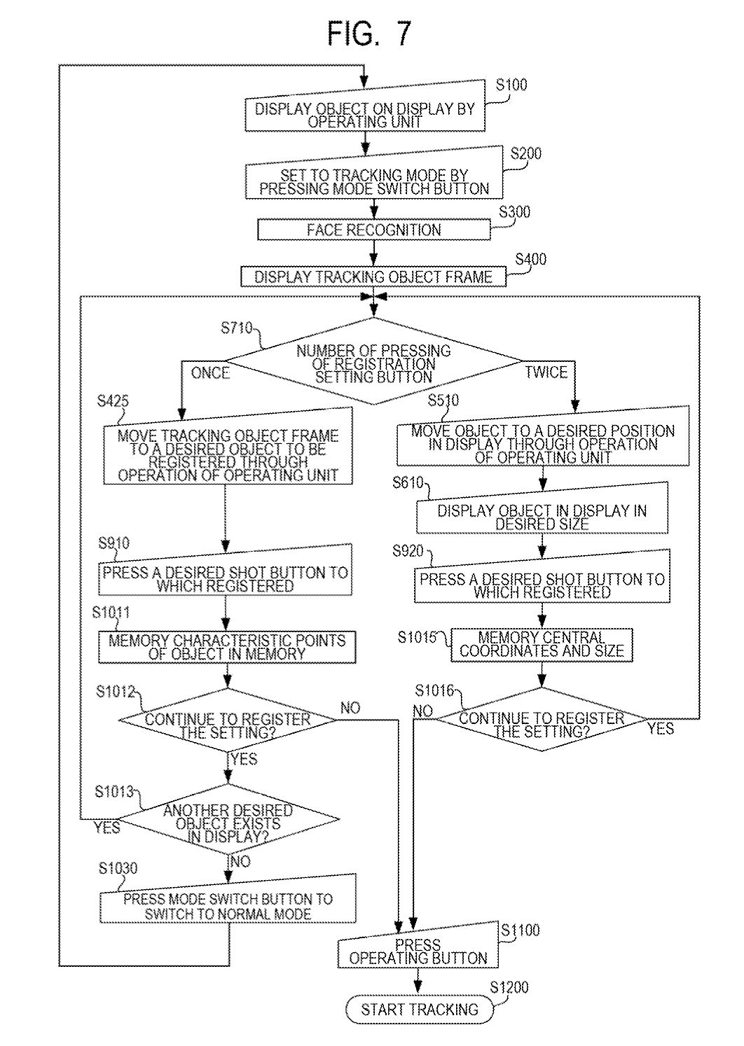

FIG. 7 is a flowchart before the start of tracking according to the third embodiment. Steps S100 to S400 are the same as steps S100 to S400 in the second embodiment, and a detailed description thereof will not be repeated.

After the tracking object frame is displayed on the display in step S400, the registration mode shifts to the object registration mode (step S425 and subsequent steps) or the composition/angle of field registration mode (step S510 and subsequent steps) by pressing the registration setting button 15 by a predetermined number of times (step S710).

More specifically, when the operator wants to register the characteristic points of an object, he sets the object registration mode by pressing the registration setting button 15 once. Then, the operator moves a tracking object frame Fr to an object to be registered through the operation of an operating unit 9 (step S425). If the operator presses one shot button 16 to which the setting is to be registered (step S910), the characteristic points of the object are stored in a memory 17 (first memory) (step S1011).

If the operator continues object registration, the process advances to steps S1012 and S1013. If another object to be registered is displayed on the display, steps S710 to S1013 are repeated. If an object to be registered is not displayed on the display, the operator temporarily returns the tracking mode to the normal mode by pressing the mode switch button 8 (step S1030), and operates the operating unit 9 so that an object to be registered is displayed on the display. That is, the process returns to the first step S100 to perform the subsequent procedures.

If the operator is to register the composition and angle of field of an object, he sets the composition/angle of field registration mode by pressing the registration setting button 15 twice in step S710. Then, similar to the first and second embodiments, the operator sets the output position and size of the object on the display (steps S510 and S610). If the operator presses one shot button 16 to which the setting is to be registered (step S920), the central coordinates and size of the tracking object frame are stored in the memory 17 (second memory) (step S1015). If the operator continues registration setting again, steps S710 to S1015 are repeated.

If the operator wants to start tracking, he presses an operating button 10 in step S1012 or S1016 (step S1100), and starts the tracking operation (step S1200).

The method of separately performing registration of an object and setting of a composition and angle of field has been described.

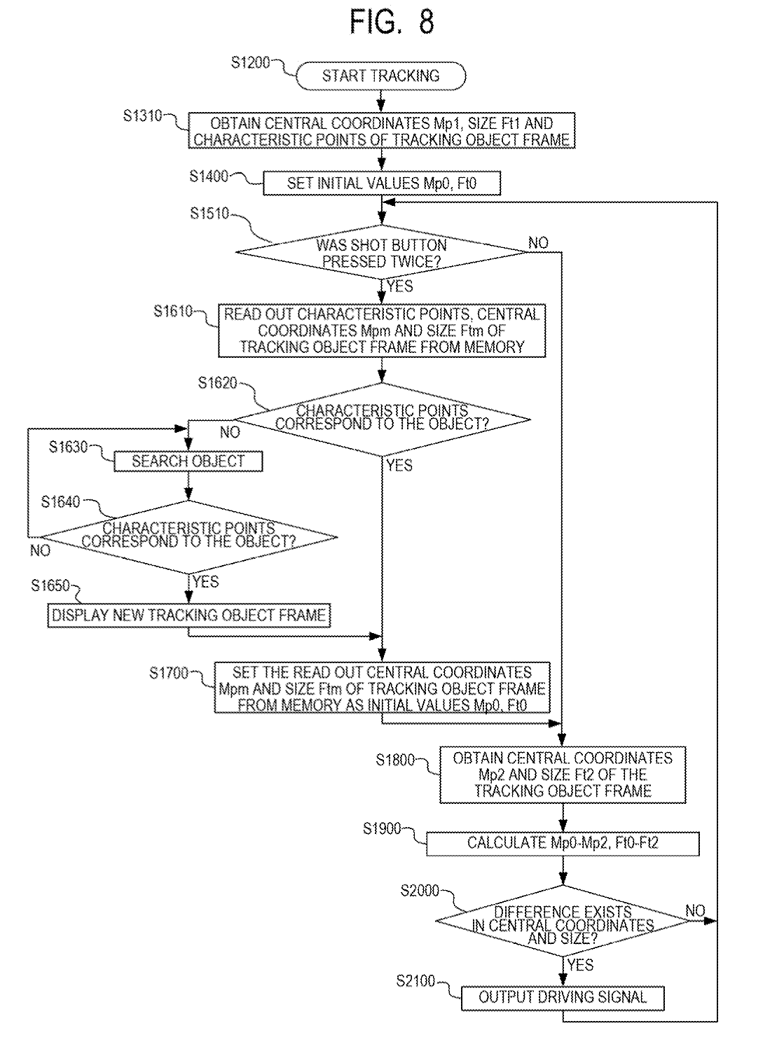

FIG. 8 is a flowchart showing a method of changing a desired tracking object, composition, and angle of field after the start of tracking.

After tracking starts, the third embodiment is the same as the second embodiment except that the shot button 16 is pressed twice in step S1510, so only step S1510 will be explained.

When the operator wants to change a desired tracking object, composition, and angle of field, he first presses one shot button 16 (first readout unit) to which the desired tracking object has been registered. Then, the operator presses one shot button 16 (second readout unit) to which a desired composition and angle of field have been registered. The characteristic points of the desired tracking object are read out from the memory 17 (first memory) in response to the first pressing of the shot button 16. The central coordinates and size of the tracking object frame are read out from the memory 17 (second memory) in response to the second pressing of the shot button 16. That is, a desired tracking object, composition, and angle of field can be freely changed by a combination of the shot buttons 16 which have been pressed in the first pressing and in the second pressing.

In the third embodiment, both the output position and size of an object are registered in one shot button 16 in the composition/angle of field registration mode. Alternatively, a composition registration mode and angle of field registration mode may be set to singly register a composition and angle of field. In other words, a desired tracking object, composition, and angle of field can be freely changed by setting the object registration mode, composition registration mode, angle of field registration mode, and combining them.

It is also possible to independently store the output position and size of an object on the display, and the central coordinates and size of a tracking object frame in the memory 17 (second memory and third memory) by pressing shot buttons 16 to which the setting is to be registered, and designate the registered central position and size of the tracking object frame by pressing the shot buttons (second readout unit and third readout unit) to which the setting is registered.

The first, second, and third embodiments have described the controlling apparatus for the automatic tracking camera. However, the present invention is also applicable to an automatic tracking camera system and the like. More specifically, the present invention is also applicable to an automatic tracking camera system including all the camera 1, electrical camera platform 2, and operating apparatus 3 shown in FIG. 1. The automatic tracking camera system preferably includes a display unit such as the monitor 14 for observing an image picked up by the camera 1.

That is, the automatic tracking camera system includes the camera 1, the electrical camera platform 2 supporting the camera 1, and the operating apparatus 3. The operating apparatus 3 includes an output position setting unit that sets a position to which a tracking object is output on the display, a selection unit that selects a desired tracking object, and a unit that registers and reads out the characteristic points of an object, a composition, and an angle of field. The object selection unit, and a setting unit that sets tracking conditions such as the output position can be arranged on a touch panel display unit. In this case, the operator can touch and select a tracking object, and move it on the display unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-119815, filed May 25, 2012, which is hereby incorporated by reference herein in its entirety.

What is claimed is:

1. A controlling apparatus for an automatic tracking camera for automatically tracking an object by controlling pan/tilt driving and zoom driving of an image pickup apparatus mounted on a camera platform apparatus, comprising:
an object recognition unit that recognizes an object by image recognition in a picked-up image;
a setting unit that sets a tracking condition of a tracking object;
a memory that stores at least one tracking condition set by the setting unit;
a readout unit that reads out the at least one tracking condition stored in the memory; and
a controlling unit that controls pan/tilt driving of the camera platform apparatus and zoom driving of the image pickup apparatus to track the tracking object under the tracking condition read out from the memory by the readout unit,
wherein the tracking condition includes an output position serving as a position to which the tracking object is output in the picked-up image, and a display size serving as a size of the tracking object to be displayed in the picked-up image,
the setting unit includes an output position setting unit that sets the output position, and a display size setting unit that sets the display size,
the memory stores at least one of the output position set by the output position setting unit, and the display size set by the display size setting unit, and
the readout unit reads out at least one of the output position and the display size that is stored in the memory.

2. An controlling apparatus according to claim 1, wherein
the memory stores at least one combination of the output position set by the output position setting unit, and the display size set by the display size setting unit,
the readout unit reads out one combination from the at least one combination of the output position and the display size that is stored in the memory, and
the controlling unit controls pan/tilt driving of the camera platform apparatus and zoom driving of the image pickup apparatus to display the tracking object at the output position read out by the readout unit and at the readout display size.

3. An controlling apparatus according to claim 1, wherein
the tracking condition includes designation of an object to be tracked,
the controlling apparatus further includes an object selection unit that selects one object from objects recognized by the object recognition unit,
the memory stores at least one of object identifying information for identifying the object selected by the object selection unit, the output position set by the output position setting unit, and the display size set by the display size setting unit, and
the readout unit reads out at least one of the object identifying information, the output position, and the display size that is stored in the memory.

4. An controlling apparatus according to claim 3, wherein
the memory stores at least one combination of the object identifying information for identifying the object selected by the object selection unit, the output position set by the output position setting unit, and the display size set by the display size setting unit,
the readout unit reads out one combination from the at least one combination of the object identifying information, the output position, and the display size that is stored in the memory, and
the controlling unit searches in a picked-up image, as the tracking object, an object having the readout object identifying information, and when the tracking object is recognized, controls pan/tilt driving of the camera platform apparatus and zoom driving of the image pickup apparatus to display the tracking object at the output position read out by the readout unit and at the readout display size.

5. An controlling apparatus according to claim 4, wherein
the memory includes a first memory that stores the object identifying information for identifying the object selected by the object selection unit, and a second memory that stores at least one combination of an object output position set by the output position setting unit, and the display size set by the display size setting unit,
the readout unit includes a first readout unit that reads out the object identifying information stored in the first memory, and a second readout unit that reads out one combination from the at least one combination of the output position and the display size that is stored in the second memory, and
when the first readout unit reads out the object identifying information stored in the first memory and the second readout unit reads out the output position and the display size that are stored in the second memory, the controlling unit searches in a picked-up image, as the tracking object, an object having the object identifying information, and when the tracking object is recognized, controls pan/tilt driving of the camera platform apparatus and zoom driving of the image pickup apparatus to display the tracking object at the readout output position and the readout display size.

6. An controlling apparatus according to claim 3, wherein
the memory includes a first memory that stores the object identifying information for identifying the object selected by the object selection unit, a second memory that stores an object output position set by the output position setting unit, and a third memory that stores the display size set by the display size setting unit,
the readout unit includes a first readout unit that reads out the object identifying information stored in the first memory, a second readout unit that reads out the output position stored in the second memory, and a third readout unit that reads out the display size stored in the third memory, and
the controlling unit searches in a picked-up image, as the tracking object, an object having the object identifying information based on the object identifying information read out by the first readout unit, the output position read out by the second readout unit, and the display size read out by the third readout unit, and when the tracking object is recognized, controls pan/tilt driving of the camera platform apparatus and zoom driving of the image pickup apparatus to display the tracking object at the readout output position and the readout display size.

7. An controlling apparatus according to claim 1, wherein the memory includes at least one registration unit that stores at least one of a pan position, tilt position, zoom position, and focus position of the automatic tracking camera when image pickup by automatic tracking is not performed, and the readout unit includes at least one readout unit that reads out at least one of the pan position, tilt position, zoom position, and focus position of the automatic tracking camera when image pickup by automatic tracking is not performed.

8. An automatic tracking camera for automatically tracking an object by controlling pan/tilt driving and zoom driving of an image pickup apparatus mounted on a camera platform apparatus, the automatic tracking camera comprising a controlling apparatus, the controlling apparatus comprising:
an object recognition unit that recognizes an object by image recognition in a picked-up image;
a setting unit that sets a tracking condition of a tracking object;
a memory that stores at least one tracking condition set by the setting unit;
a readout unit that reads out the at least one tracking condition stored in the memory; and
a controlling unit that controls pan/tilt driving of the camera platform apparatus and zoom driving of the image pickup apparatus to track the tracking object under the tracking condition read out from the memory by the readout unit,
wherein the tracking condition includes an output position serving as a position to which the tracking object is output in the picked-up image, and a display size serving as a size of the tracking object to be displayed in the picked-up image,
the setting unit includes an output position setting unit that sets the output position, and a display size setting unit that sets the display size,
the memory stores at least one of the output position set by the output position setting unit, and the display size set by the display size setting unit, and
the readout unit reads out at least one of the output position and the display size that is stored in the memory.
